(19) United States
(12) Patent Application Publication
(10) Pub. No.: US 2008/0145287 A1
(43) Pub. Date: Jun. 19, 2008

(54) System for the Treatment of Powdered Material

(76) Inventors: Roberto Trebbi, Castenaso (IT); Elvio Gasperini, Castel S. Pietro Terme (IT); Vittoriano Marcheschi, Lappato (IT); Patrizia Nanni, Lappato (IT); Laura Marcheschi, Lappato (IT); Chiara Marcheschi, Lappato (IT)

Correspondence Address: ARENT FOX LLP, 1050 CONNECTICUT AVENUE, N.W., SUITE 400, WASHINGTON, DC, 20036, US

(21) Appl. No.: 11/795,717

(22) PCT Filed: Feb. 2, 2006
(86) PCT No.: PCT/IB06/00356

§ 371 Date: Jul. 20, 2007

(30) Foreign Application Priority Data
Feb. 23, 2005 (IT) BO2005A000094

(51) Int. Cl. B01J 19/00

(52) U.S. Cl. 422/291; 422/243

(57) ABSTRACT

A system (1) for the treatment of powdered material, in particular pharmaceutical powders, comprising, with the possibility of suitable connection between them using pipe means (4), at least a first operating unit (2) designed for mixing the powdered material with other substances to obtain a predetermined mixture, and at least a second operating unit (3) designed for subjecting the mixture to a fluid bed type treatment. The first unit (2) is supported in such a way that it is mobile relative to the second unit (3); there being means (8, 7, 13) for supporting and moving the first unit (2), for moving the first unit (2) alternatively in a predetermined direction (F) relative to the second unit (3), between a first and a second operating position (A, B).

### TECHNICAL FIELD

The present invention relates to an integrated system for the treatment of powdered material, in particular powdered material for use in the pharmaceutical sector, to which specific reference is made in the following description, without thereby limiting the scope of the invention.

### BACKGROUND ART

At present, in the technology for use of pharmaceutical powders, apparatuses are known, commonly referred to by experts in the field as granulator devices, which are used to subject powders to a treatment which normally uses a flow of operating fluid, that is to say a gaseous fluid or nebulised liquid, depending on circumstances, used, for example, to dry, agglomerate, mix, wash and transport pharmaceutical powders.

In general, a known granulator device is of the type comprising a first independent mixing unit, consisting of a chamber, into which the active ingredient and suitable additives and/or excipients are usually fed, to form a required pharmaceutical compound or mixture, which is then introduced, by a sealed transport pipe, into a second unit, independent and separate from the first unit, and designed to perform a subsequent treatment on the mixture.

Said second unit comprises a fluid bed container (mainly extending vertically) with sealed walls delimiting a chamber for treatment of the powders, having permanent separator filters, with solid walls, delimiting the above-mentioned treatment chamber and means for feeding an operating fluid flow, acting on the mixture.

At present, in the spatial layout of the above-mentioned first and second treatment units the first treatment unit for mixing is upstream of the second unit connected to it by the afore-mentioned pipe, and located in a fixed fashion at a height greater than that of the second unit. This promotes transportation of the mixture downwards from the first unit towards the base or bottom of the second unit where, by means of air eddies, the above-mentioned fluid treatment of the mixed powders is performed.

A granulator device of the type described above is the cause of several disadvantages, due in particular to the layout of the units on two separate support surfaces or levels, at different heights.

Said layout on two different levels not only means that the dimensions of the granulator device are considerable, but above all necessitates the presence of two skilled operators, one for the mixing unit and one for the fluid bed unit, these operators controlling operation of the respective unit using a computerised interface.

Moreover, since in the above-mentioned granulator device each unit has a drainage pipe, through which, after normal and periodic operations for cleaning the respective chamber, the washing liquids are discharged. Consequently the presence of two separate drainage systems makes management of washing waste liquids complex and difficult.

Obviously, all of this considerably increases the costs of the granulator device, intervention times in the event of faults or checks on the two different units located on different levels, and times for material feed and restoring operation of the units.

### DISCLOSURE OF THE INVENTION

The aim of the present invention is, therefore, to overcome the above-mentioned disadvantages by providing an integrated system for the treatment of powdered products, in particular products intended for pharmaceutical use, which has compact dimensions and whose operation can be controlled and inspected by a single operator.

Accordingly, the present invention provides a system for the treatment of powdered material, in particular pharmaceutical powders, comprising, with the possibility of suitable connection between them using pipe means, at least a first operating unit designed for mixing the powdered material with other substances to obtain a predetermined mixture, and at least a second operating unit designed for subjecting the mixture to a fluid bed type treatment; the system being characterised in that the first unit is supported in such a way that it is mobile relative to the second unit; there being means for supporting and moving the first unit which move the first unit alternatively in a predetermined direction relative to the second unit, between a first and a second operating position.

### BRIEF DESCRIPTION OF THE DRAWINGS

The technical characteristics of the invention are described in the claims below and its advantages are more apparent from the detailed description which follows, with reference to the accompanying drawings which illustrate a preferred embodiment of the invention provided merely by way of example without restricting the scope of the inventive concept, and in which:

FIG. 1 is a perspective view of a preferred embodiment of a system for the treatment of powdered products in accordance with the present invention;

FIG. 2 is a front view of the system illustrated in FIG. 1, partly in cross-section and with some parts cut away for clarity;

FIG. 3 is a top plan view of the system illustrated in FIG. 1 and FIG. 2.

### DETAILED DESCRIPTION OF THE PREFERRED EMBODIMENTS OF THE INVENTION

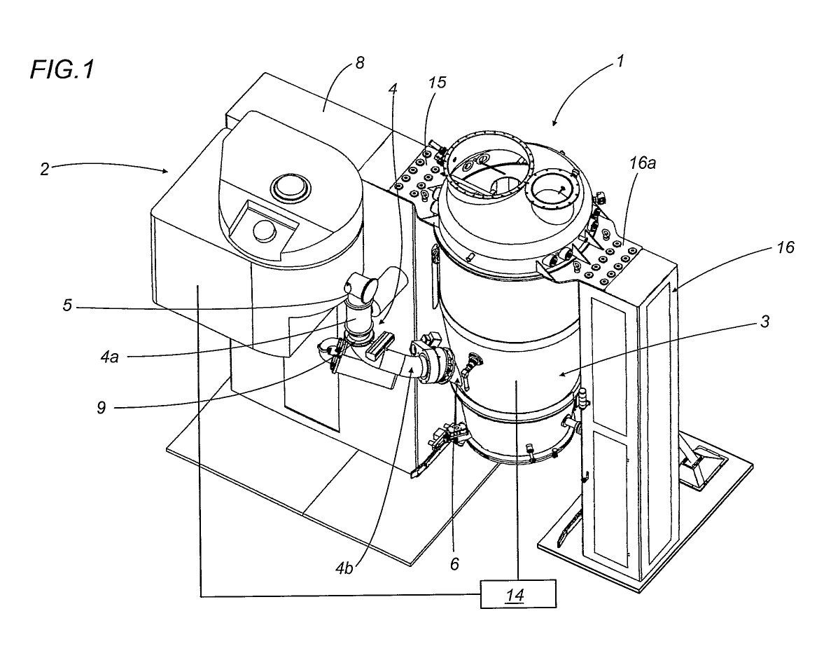

With reference to FIGS. 1, 2 and 3, the numeral 1 denotes as a whole a system for the treatment or granulation of powdered material, preferably powdered pharmaceutical material (not illustrated).

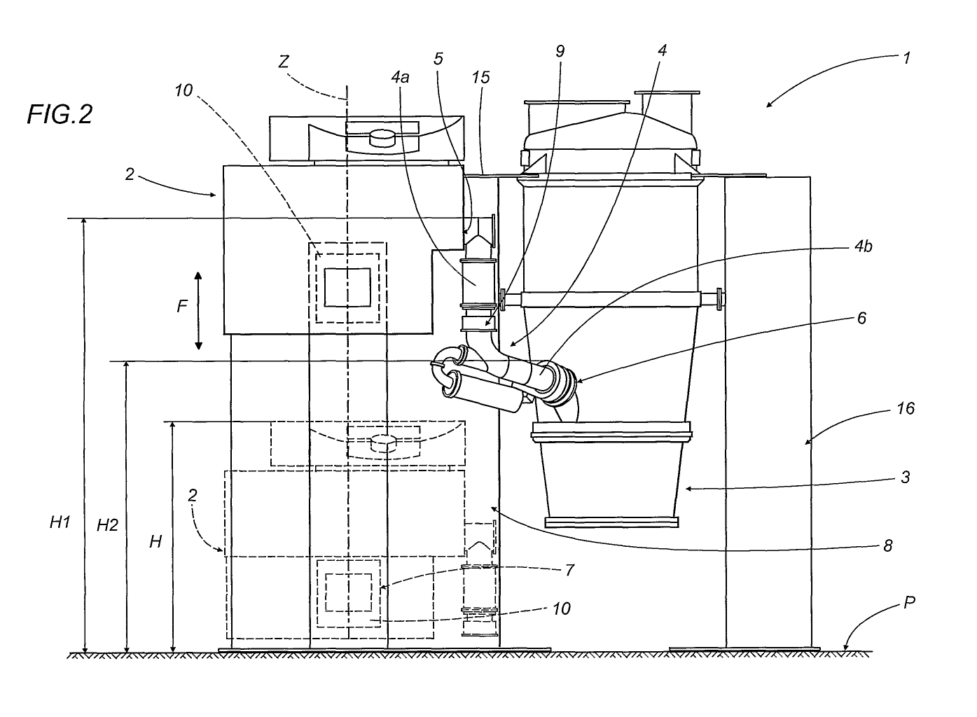

The system 1 comprises a first operating unit 2 designed for mixing the powdered material and consisting of a first chamber 2a (FIG. 2), into which the powdered pharmaceutical material to be treated and an additive and/or excipient to be mixed with said material to form a compound or mixture are introduced; a second operating unit 3 designed for subjecting the mixture to a fluid treatment, consisting of a second mixture treatment chamber 3a (FIG. 2); sealed means or pipes 4 for feeding and transporting the mixture from the first unit 2 to the second unit 3, said means 4 connecting a respective first and second circular outlet hole, labelled 5 and 6, in the first and the second unit 2 and 3, respectively.

The holes 5 and 6 are located at different heights to one another relative to a base surface or working tread surface P.

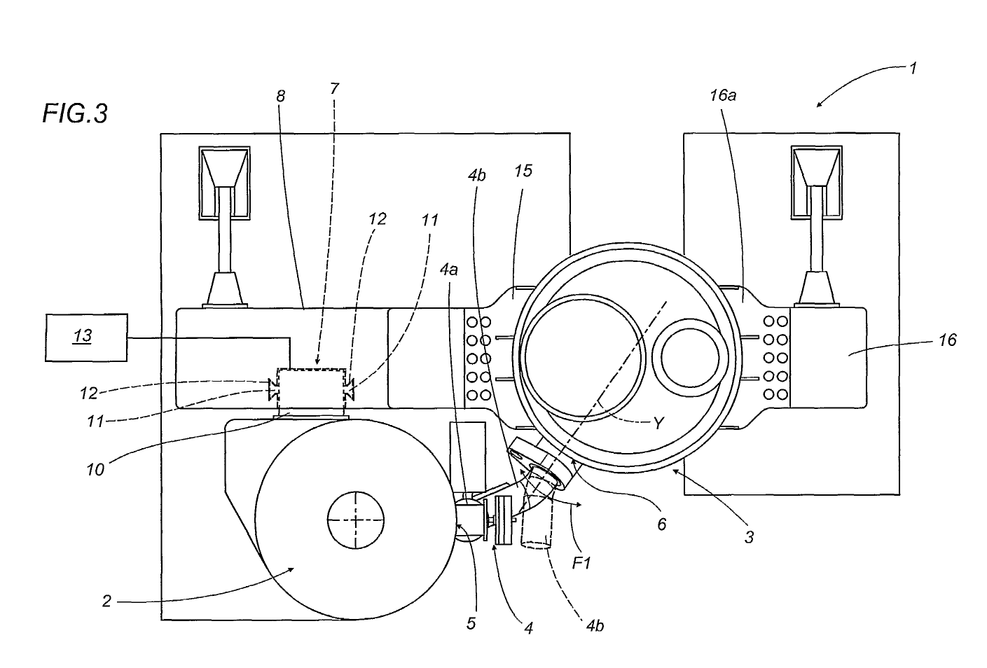

As illustrated in FIGS. 2 and 3, the first unit 2 is vertically mobile and has means 7 for moving the first unit 2 along a vertical axis Z and mobile between two limit operating positions (arrows F in FIG. 2), that is to say, between a first, lowered position A (illustrated with a dashed line in FIG. 2), in which the first unit 2 is located close to the tread surface P to allow the introduction into the chamber 2a of the powdered material to be treated and the additive/excipient substances, and a second, raised operating position B (illustrated with a continuous line in FIG. 2).

In practice, in use in the second, operating position B the first hole 5 in the first unit 2 is at a height H1 greater than the height H2 of the second hole 6 in the second unit 3.

Specifically, in the system 1 the first unit 2 preferably, but without limiting the scope of the invention, consists of a mixing unit with a horizontal or vertical axis and of the known type using rotary vanes or blades (for example, that produced and marketed by the Applicant under the name “VORTEX”), whilst the second unit 3 preferably consists of a container or silo of the known fluid bed type (for example that produced and marketed by the Applicant under the name “GHIBLI”), substantially cylindrical and mainly extending vertically for treating mixed powders using a flow of operating fluid, that is to say a gaseous fluid or nebulised liquid which, depending on circumstances, is used, for example, to dry, agglomerate, wash, support, coat the powders.

As can be seen in FIG. 2, the first unit 2 is positioned, at the above-mentioned lowered position A, with the first hole 5 at a height H less than the height H2 of the second hole 6, again relative to the tread surface P.

Again as illustrated in the accompanying drawings from 1 to 3, the first unit 2 and the second unit 3 are coupled to a shared first column element 8, with the unit 3 mounted in a fixed fashion, as described in more detail below, to the element 8 and to another column element 16, whilst the unit 2 is mounted in such a way that it is mobile on the element 8, which therefore supports the first unit 2 means 7 for movement along the vertical axis Z.

More specifically, as is better illustrated in FIGS. 2 and 3, said movement means 7 comprise a removable retaining plate 10, for the first unit 2, projecting from the first column element 8, and having at least one pair of slides 11, slidably coupled to relative vertical guides 12 located inside the first column element 8, and mobile, driven by a drive unit 13 (illustrated as a block with a dashed line).

Obviously, the plate 10 is shaped to allow the passage of feed units (electrical, digital, fluids) from the first column element 8 towards the first unit 2, to allow its normal operation.

The first column element 8, preferably having the shape of a parallelepiped, has, on one of its longer surfaces, the first unit 2 vertical movement means 7 and, on one of its shorter surfaces, first support means 15 for the second unit 3; said first support means 15 consisting of first projecting fixing plates for the unit 3.

The second unit 3 is also supported in a fixed fashion, on the opposite side to the first plates 15, by the above-mentioned second column element 16, which has second fixing plates 16a for the second unit 3.

Again as illustrated in FIGS. 1, 2 and 3, the above-mentioned pipe means 4 for feeding and transporting the mixture from the first unit 2 to the second unit 3 comprise two sections 4a and 4b of a connecting pipe, where the first section 4a extends from the first hole 5 in the first unit 2, and the second section 4b extends from the second hole 6 in the second unit 3. The feed means 4 preferably also support and comprise milling means (not illustrated) designed to grind/filter/crumble any lumps of mixture formed in the chamber 2a during the step of mixing the powdered material and the additives/excipients.

The two sections 4a and 4b can be connected to one another, in a sealed fashion, at a respective free end, each of which can be placed opposite the other, and using means 9 for a sealed removable connection. In this way, the two sections 4a and 4b can be detached to allow vertical movement of the first unit 2 relative to the unit 3.

As illustrated in FIG. 3, the second section 4b of the pipe connected to the second unit 3 extends in such a way that it is at least partly curved at its free end for connection to the first section 4a.

This is because the second section 4b can be rotated, at the second end connected to the second opening 6, about its Y axis extending radially to the second chamber, between a first, operating position, in which at least the free end of the second section 4b of pipe is opposite and can be connected in a sealed fashion to the end of the first section 4a (continuous line in FIG. 3), and a second, detached position, in which the free end of the second section 4b of pipe is distanced from the first section 4a of pipe, so that the first unit 2 can move vertically without interference or impediment on the first section 4a (dashed line and arrow F1 in FIG. 3).

The two units 2 and 3, being arranged relative to one another in such a way that they are integrated on a single support structure, can, from the operating viewpoint, advantageously be managed and controlled by a single operator using a single interface unit 14 for controlling the two units 2 and 3, of the known type and schematically illustrated as a block in FIG. 1.

Operation of the system 1 can easily be described starting with positioning of the unit 2 in the lowered position A on the surface P, where a single operator can conveniently fill up by loading the powdered material to be treated and the additive/excipient substances in the chamber 2a of the unit 2.

Once the material has been loaded in the chamber 2a, the operator uses a suitable push-button on the interface 14 to give the command for vertical lifting of the unit 2, to move the unit 2 from position A to position B, then by rotating the section 4b of pipe 4 about the axis Y, connects the section 4b to the section 4a, in this way creating the connection between the hole 5 in the unit 2 and the hole 6 in the unit 3.

When this connecting operation is complete, the operator can begin treatment of the powdered material, which is first mixed with additives/excipients to create a mixture, which is then fed downwards, passing along the pipe 4, from the chamber 2a of the unit 2 to the chamber 3a of the unit 3, and is then subjected to the fluid treatment to allow its optimum agglomeration and/or drying.

Finally, it should be noticed that the sequence of operating steps just described for system 1 operation is also advantageously used for washing/sterilising the system 1, for example at the end of the operating cycle. In other words, introduction of the sterilising washing liquid in the chamber 2a is conveniently performed when the unit 2 is in its lowered position A on the surface P, and the washing cycle is started once the unit 2 has been moved to the raised position B and the hole 5 has been connected to the hole 6 using the pipe 4.

In this way, at the end of the washing/sterilising cycle, the liquid used for washing is advantageously drained by having it come out of a single drainage pipe (not illustrated) located on the base of the silo type container belonging to the unit 3 only, allowing very easy management of the waste liquids.

Another advantage of the structure of the system 1 with one unit mobile relative to the other is the fact that successive and repeated additional loads of powdered material to be treated are possible (again with the unit 2 in its lowered position A) even with the unit 3 continuously operating, partly thanks to the presence of the connecting means 9, which guarantee sealed isolation of the unit 3.

The invention described can be modified and adapted in several ways without thereby departing from the scope of the inventive concept. Moreover, all technical details of the invention may be substituted by technically equivalent elements.

1. A system (1) for the treatment of powdered material, in particular pharmaceutical powders, comprising, with the possibility of suitable connection between them using pipe means (4), at least a first operating unit (2) designed for mixing the powdered material with other substances to obtain a predetermined mixture, and at least a second operating unit (3) designed for subjecting the mixture to a fluid bed type treatment; the system being characterised in that the first unit (2) is supported in such a way that it is mobile relative to the second unit (3); there being means (8, 7, 13) for supporting and moving the first unit (2), which move the first unit (2) alternatively in a predetermined direction (F) relative to the second unit (3), between a first and a second operating position (A, B).

2. The system according to claim 1, characterised in that the direction (F) is a vertical direction; at the first operating position (A) the first unit (2) being located substantially on a working surface (P), at the second operating position (B) the first unit (2) being raised relative to the working surface (P) with its opening hole (5) located at a height (H1) which is greater than that of the surface (P).

3. The system according to claim 1 or 2, characterised in that the first operating position (A) is a position for loading the first unit (2) with the powdered material and the other substances, the first unit (2) being disconnected from the second unit (3); the second operating position (B) being a first unit (2) mixing operating position, with its hole (5) connected, by the pipe means (4), to a hole (6) in the second unit (3).

4. The system according to claim 3, characterised in that in the second operating position B the outlet hole (5) in the first unit (2) is located, relative to a working surface (P), at a height (H1) greater than the height (H2) of the outlet hole (6) in the second unit (3).

5. The system according to any of the foregoing claims from 1 to 4, characterised in that the means (8, 7, 13) for supporting and moving the first unit (2) comprise a column element (8) and a support plate element (10) for the first unit (2), the plate element (10) having at least one pair of slides (11), being slidably coupled to relative vertical guides (12) located inside the column element (8); and there being drive means (13) coupled to the slides (11) to move the first unit (2) vertically in the direction (F) between the first and the second operating positions (A, B).

6. The system according to claim 5, characterised in that the second unit (3) is supported in a fixed fashion by the column element (8) and by another column element (16) using respective support plate means (15, 16a).

7. The system according to any of claims 1-4, characterised in that the pipe means (4) comprise a first and a second section (4a; 4b) of a tubular pipe (4), where the first section (4a) extends and is connected to the first hole (5) in the first unit (2), and the second section (4b) extends and is connected to the second hole (6) in the second unit (3); there being the possibility of connecting the first and second sections (4a; 4b), using means (9) for a sealed removable connection; at least one (4b) of the first and second sections (4a; 4b) being mounted in such a way that it is mobile, rotating about its axis (Y) between a first operating position, in which the section (4b) is coupled and connected to the other section (4a), and a second, detached position, in which the section (4b) is disconnected from the other section (4a).

8. The system according to claim 7, characterised in that the pipe means (4) comprise milling means designed to grind/filter/crumble the mixture coming out of the first unit (2).

9. The system according to claim 5, characterised in that the pipe means (4) comprise a first and a second section (4a; 4b) of a tubular pipe (4), where the first section (4a) extends and is connected to the first hole (5) in the first unit (2), and the second section (4b) extends and is connected to the second hole (6) in the second unit (3); there being the possibility of connecting the first and second sections (4a; 4b), using means (9) for a sealed removable connection; at least one (4b) of the first and second sections (4a; 4b) being mounted in such a way that it is mobile, rotating about its axis (Y) between a first operating position, in which the section (4b) is coupled and connected to the other section (4a), and a second, detached position, in which the section (4b) is disconnected from the other section (4a).

10. The system according to claim 9, characterised in that the pipe means (4) comprise milling means designed to grind/filter/crumble the mixture coming out of the first unit (2).
